(19) United States
(12) Patent Application Publication
(10) Pub. No.: US 2011/0281085 A1
(43) Pub. Date: Nov. 17, 2011

(54) POLYMER THIN FILM, PATTERNED MEDIA, PRODUCTION METHODS THEREOF, AND SURFACE MODIFYING AGENTS

(76) Inventors: Yasuhiko TADA, Hitachinaka (JP); Hiroshi Yoshida, Mito (JP); Teruaki Hayakawa, Tokyo (JP); Tomoyasu Hirai, Fukuoka (JP); Yoshihito Ishida, Tokyo (JP)

(21) Appl. No.: 13/106,091

(22) Filed: May 12, 2011

(30) Foreign Application Priority Data
May 14, 2010 (JP) 2010-112457

(51) Int. Cl. B32B 3/10; C08L 83/00; B05D 5/00

(52) U.S. Cl. 428/195.1; 427/256; 525/100

(57) ABSTRACT

The objects of the present invention are to provide a polymer thin film having finer structure than the conventional product, excellent regularity over a wide range and only limited defects, patterned media, methods for producing the thin film and patterned media, and surface modifying agent used in these production methods.

The method of the present invention is for producing a polymer thin film with a plurality of microdomains regularly arranged in a continuous phase by microphase separation on a substrate, comprising steps for forming a grafted silsesquioxane film on the substrate, and for forming a pattern different in chemical properties from the grafted silsesquioxane film in such a way that the pattern corresponds to the microdomain arrangement.

### TECHNICAL FIELD

The present invention relates to a polymer thin film having a microstructure formed by microphase separation of a block copolymer on a substrate, patterned media using the polymer thin film, methods for producing the thin film and patterned media, and surface modifying agent used in these production methods.

### BACKGROUND OF THE INVENTION

Recently, demands have been increasing for fine, regularly arranged patterns having a size of several nanometers to several hundreds of nanometers formed on substrates to satisfy the requirements for compacter, more functional electronic devices, energy-storage devices, sensors and so on. Therefore, demands have been also increasing for establishing processes which can produce fine, regularly arranged patterns (hereinafter simply referred to as the “microstructures”) at high accuracy and low cost.

The top-down procedures represented by lithography have been generally adopted for producing these microstructures, in which a bulk material is finely divided. Photolithography, which is adopted to produce fine semiconductors, e.g., LSIs, is the representative lithography.

One of the methods for microphase separation of a block copolymer formed on a substrate is the chemical registration, in which patterned regions having different chemical properties are formed on a substrate to control evolution of microdomains by utilizing different chemical interactions between the substrate surface and block copolymer (for example, refer to Patent Documents 1 and 2. This method adopts a top-down procedure, in which chemically patterned regions having different wettability with each block chain (polymer segment) are formed beforehand on a substrate. More specifically, when a polystyrene/polymethyl methacrylate diblock copolymer is used, regions having affinity for polystyrene and those having affinity for polymethylmethacrylate are individually formed on a substrate to have chemical patterns. These patterns, when formed to correspond to the microphase-separated structure of the diblock copolymer, allow to dispose the microdomains of the polystyrene in the regions having affinity for (or wettability with) polystyrene and those of polymethylmethacrylate in the regions having affinity for (or wettability with) polymethylenemethacrylate. The top-down procedure for forming the chemical patterns by chemical registration secures regularity of the patterns over a long distance, thus giving the highly regular microstructures having limited defects over a wide range.

The block copolymers with the microdomains upstanding on a substrate, i.e., extending in the substrate thickness direction, in the continuous phases include a polymethylmethacrylate copolymer containing polymethylmethacrylate/block/polyhedral oligomeric silsesquioxane (hereinafter sometimes referred to as POSS) having POSS in the side chain, and polymethylmethacrylate copolymer containing polystyrene/block/POSS (for example, refer to Non-patent Document 1).

It is considered that a block copolymer having the siloxane bond can give finer microphase-separated structure, because it has a larger interaction parameter than a polystyrene/polymethyl methacrylate diblock copolymer.

### PRIOR ARTS

[Patent Documents]
[Patent Document 1] U.S. Pat. No. 6,746,825
[Patent Document 2] U.S. Pat. No. 6,926,953

[Non-Patent Document]
[Non-patent Document 1] Macromolecules, 2009, 42, 8835-8843

### SUMMARY OF THE INVENTION

However, the top-down procedure needs larger-size devices and more sophisticated processes as the microstructures become finer to increase the production cost. In particular, it needs vast investments when fabrication size of the microstructures decreases to an order of several tens of nanometers, because electron beams or deeply ultraviolet rays are needed for the patterning. Moreover, fabrication throughput will greatly decrease, when formation of the microstructures with masks becomes difficult, because it needs the direct drawing procedure.

Under these situations, processes which use self-assembly, a phenomenon in which a substance naturally forms the structure, have been attracting attention. In particular, processes which use microphase-separated block copolymers are advantageous in that they can form various shapes of microstructures of several tens to several hundreds of nanometers by a simple embrocation process. When dissimilar polymer segments are incompatible with each other in a block copolymer, these segments form the structure in which spherical, columnar or layered microdomains are arranged regularly in the continuous phase by the microphase separation.

One of the methods for forming the microstructures using the microphase separation include the one which causes the microphase separation of the thin film of a block copolymer of polystyrene and polybutadiene, polystyrene and polyisoprene, polystyrene and polymethacrylate or the like on a substrate, and etches the substrate with the thin film serving as the mask to form, on the substrate, the holes or lines-and-spaces having a shape corresponding to the microdomains in the thin film.

More recently, demands have been increasing for the finer microphase-separated structures for satisfying the requirements for compacter, more functional electronic devices or the like.

However, the chemical registration cannot give microphase-separated structures smaller than tens or more nanometers, when a polystyrene/polymethyl methacrylate diblock copolymer is used to form these structures, because of its insufficient interaction parameter.

It is necessary to form regions having different chemical properties on a substrate in order to control evolution of the microdomains of a block copolymer containing the siloxane bond by the chemical registration. However, the conventional chemical registration has limited combinations of chemical patterns of the copolymer on a substrate. Therefore, the conventional chemical registration is inapplicable to the microphase separation of the copolymer containing the siloxane bond.

In other words, the conventional chemical registration cannot form a finer structure having excellent regularity over a wide range and only limited defects on a substrate.

The objects of the present invention are to provide a polymer thin film having finer structures, excellent regularity over a wide range and only limited defects on a substrate, patterned media, methods for producing the thin film and patterned media, and surface modifying agent used in these production methods.

The method for producing a polymer thin film of the present invention for solving the problems is a method for producing a polymer thin film, comprising the steps of:

a first step of disposing a polymer layer on a substrate, the polymer layer containing a block copolymer having at least a first segment and a second segment; and

a second step of subjecting the polymer layer to a microphase separation to regularly arrange, on the substrate in an in-plane direction, a plurality of microdomains containing the second segment component in a continuous phase containing the first segment component,

further including the step of, before the first step, forming a film of grafted silsesquioxane on the substrate in such a way that the film corresponds to the continuous phase, and forming a pattern different in chemical properties from the film of grafted silsesquioxane in such a way that the pattern corresponds to the microdomain arrangement.

The method for producing the patterned media of the present invention for solving the problems is a method for producing a patterned media, comprising the steps of:

forming, on a substrate, the polymer thin film produced by the method according to claim 1 to have a plurality of the microdomains arranged in the continuous phase; and

removing one of the continuous phase and the microdomains from the polymer thin film.

The microstructure of the present invention for solving the problems is a polymer thin film produced by the method for producing the polymer thin film of the present invention.

The patterned media of the present invention is produced by the method for producing the patterned media of the present invention, in order to solve the problems involved in the conventional chemical registration.

The surface modifying agent of the present invention for solving the problems is a surface modifying agent for modifying a surface of substrate on which a polymer thin film is to be formed,

wherein the surface modifying agent comprises a polymer compound having:

a divalent organic group having a functional group capable of coupling to a hydroxide group present on a substrate surface; and a polymer chain having, in a side chain, a monovalent functional group containing a polyhedral oligomeric silsesquioxane skeleton.

Other objects, features and advantages of the invention will become apparent from the following description of the embodiments of the invention taken in conjunction with the accompanying drawings.

### ADVANTAGES OF THE INVENTION

The present invention provides the polymer thin film having a finer structure than the conventional product, excellent regularity over a wide range and only limited defects on a substrate, patterned media, methods for producing the thin film and patterned media, and surface modifying agent used in these production methods.

### BRIEF DESCRIPTION OF THE DRAWINGS

FIG. 1 is a partially expanded oblique view, with part of cross-sectional view, illustrating the polymer thin film structure produced in one embodiment of the present invention.

FIGS. 2 (a) to (f) illustrates the process steps for patterning the substrate surface.

FIGS. 3 (a) and (b) schematically illustrates one embodiment with the grafted polyhedral oligomeric silsesquioxane film disposed on the substrate.

FIG. 4 (a) and (b) illustrates the process steps for producing the polymer thin film, adopted in one embodiment of the present invention.

FIG. 5 (a) is a conceptual view illustrating the microphase-separated block copolymer, with the second regions as the chemical marks arranged on the entire substrate surface at intervals of natural period (d₀, hexagonal natural period, refer to FIG. 1) of the block copolymer. FIG. 5 (b) is a conceptual view illustrating the microphase-separated block copolymer, with the second regions as the chemical marks arranged to have a defect rate of 25%. FIG. 5 (c) is a conceptual view illustrating a microphase-separated block copolymer, with the second regions as chemical marks arranged to have a defect rate of 50%. FIG. 5 (d) is a conceptual view illustrating a microphase-separated block copolymer, with the second regions as chemical marks arranged to have a defect rate of 75%.

FIG. 6 is a conceptual view illustrating the first and second segments in the block copolymer used for production of the polymer thin film of the present invention.

FIG. 7 (a) to (f) illustrates the steps adopted in one embodiment of the method of the present invention for producing the patterned media using the polymer thin film of microstructure.

FIG. 8 is an oblique view illustrating the block copolymer microphase-separated to have a lamellar structure.

FIG. 9 (a) is a partially expanded plan view illustrating the grafted silsesquioxane film after it is patterned, and FIG. 9 (b) is a plan view schematically illustrating the configuration of the regions of different lattice-lattice distance “d.”

FIG. 10 (a) is an AFM image illustrating the hPMMA liquid droplets on the grafted silsesquioxane film, and FIG. 10 (b) is a cross-sectional image illustrating the hPMMA liquid droplet on the grafted silsesquioxane film.

FIG. 11 (a) is an SEM image of the microphase-separated block copolymer (PMMA(4.1 k)-b-PMAPOSS (26.9 k)), and FIG. 11 (b) is a two-dimensional Fourier conversion image of the arranged columnar microdomain.

FIG. 12 (a) is an SEM image of the block copolymer produced in Example 1, wherein the microdomains are arranged with the d/d₀ ratio set at 1 (d: lattice-lattice distance, nm and d₀: natural period of the block copolymer, 24 nm), and FIG. 12 (b) is an SEM image of the block copolymer produced in Comparative Example 2.

### DETAILED DESCRIPTION OF THE INVENTION

The embodiments of the polymer thin film of the present invention are described by referring to the drawings, as required. The polymer thin film is mainly characterized by a patterned substrate on which a film of grafted polyhedral oligomeric silsesquioxane is disposed, and the block copolymer microphase-separated on the substrate surface.

Described herein are the polymer thin film, method for producing the polymer thin film, surface modifying agent used for forming the film of grafted, polyhedral oligomeric silsesquioxane, and method for producing the patterned media using the polymer thin film, in this order.

### (Polymer Thin Film)

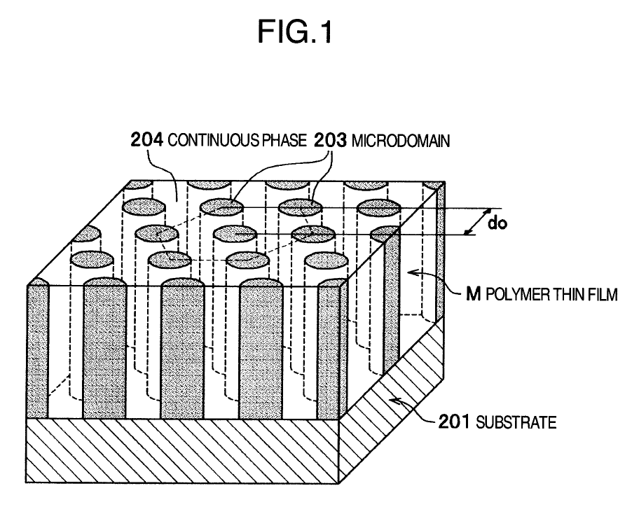

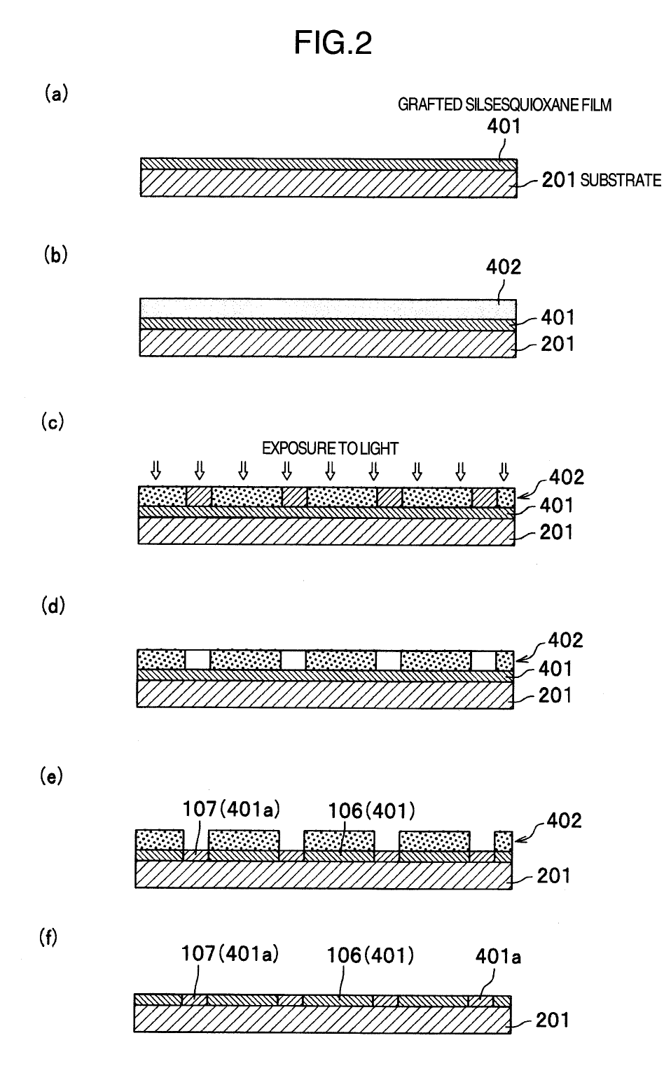

As illustrated in FIG. 1, the polymer thin film M having a microphase-separated microstructure, produced in one embodiment of the present invention, comprises a microphase-separated structure with the continuous phase 204 and columnar (cylindrical) microdomains 203, wherein the block copolymer (described later) is microphase-separated on the substrate 201 patterned to have the first regions 106 and second regions 107 (described later, refer to FIG. 2 (f)). The patterned substrate 201 surface (with the first regions 106 and second regions 107, refer to FIG. 2 (f)) is not shown in FIG. 1.

The microdomains 203 in the continuous phase 204 are regularly arranged on the substrate in the in-plane direction. More specifically, the columnar microdomains 203 oriented in the thickness direction of the polymer thin film M run in the in-plane direction of the substrate 201 to have a hexagonal close-packed structure.

The columnar microdomains 203 run through the polymer thin film M in the thickness direction in this embodiment. However, they may not run through the polymer thin film M. Moreover, the microdomains 203 are not necessarily arranged to have a hexagonal close-packed structure, and may take a cubic lattice structure or the like.

As described in more detail later, the microdomain 203 may have a lamellar (layered) or spherical structure. It is needless to say that the continuous phase 204 can have various shapes to correspond to the various microdomain 203 shapes.

The symbol “d₀” shown in FIG. 1 represents a natural period of the microdomain 203, determined in accordance with the block copolymer type, described later, for producing the polymer thin film M. The intervals at which the microdomains 203 are arranged are determined in accordance with the natural period “d₀.”

### (Method for Producing the Polymer Thin Film)

Next, the method for producing the polymer thin film is described.

The method described here is based on the chemical registration to produce the polymer thin film M with the columnar microdomains 203 upstanding on the substrate, i.e., extending in the substrate thickness direction, as illustrated in FIG. 1. FIG. 2 (a) to (f), used as the references, illustrates process steps for patterning the substrate surface.

The method first forms the film 401 of silsesquioxane on the substrate 201 (refer to FIG. 2 (a)).

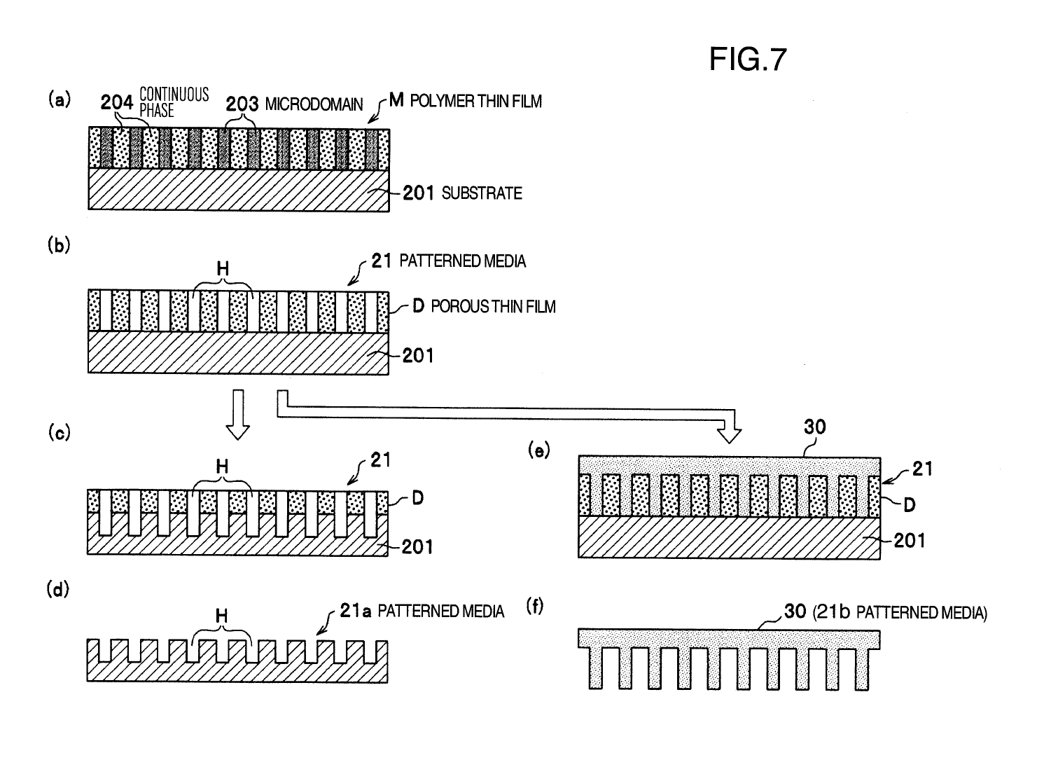

The substrate 201 used in this embodiment is of silicon (Si). The other materials useful for the substrate 201 include inorganic materials, e.g., glass and titania, semiconductors, e.g., GaAs, metals, e.g., copper, tantalum and titanium, and organic materials, e.g., epoxy resin and polyimide, depending on the patterned medias 1 described later (refer to FIG. 7 (b) or 21 described later (refer to FIG. 7 (d)).

One of the methods for forming the film 401 of grafted silsesquioxane first introduces a functional group by coupling or the like on the substrate 201 surface to provide polymerization initiation points, and forms a polymer having a silsesquioxane skeleton by polymerization starting from the initiation points. Another method first synthesizes a surface modifying agent, described later, on the substrate 201, the material being of a polymer having a functional group capable of coupling to the substrate surface at the terminal or in the main chain, and then couples the surface modifying agent to the substrate 201 surface. The latter method is recommended because of its simplicity.

Here, the method is described for forming the film 401 of grafted silsesquioxane film on the substrate 201 surface by coupling the surface modifying agent, described later, to the substrate 201 surface.

This method exposes the substrate 201 to an oxygen plasma or immerses the substrate 201 in a piranha solution to increase hydroxide group concentration in the natural oxide film formed on the substrate 201 surface. Then, a solution of the surface modifying agent, described later, dissolved in an organic solvent, e.g., toluene, is spread on the substrate 201 to form the film thereon. Then, the coated substrate 201 is heated in a vacuum oven or the like at around 190° C. for around 72 hours under a vacuum. This treatment reacts the hydroxide group on the substrate 201 surface with a functional group in the surface modifying agent, described later, to form the film of grafted silsesquioxane 401 on the substrate 201.

It is desired to set molecular weight of the surface modifying agent (of polymer) to be grafted on the substrate 201 at around 1,000 to 50,000, because thickness of the film 401 of grafted silsesquioxane can be controlled at around several nanometers.

Next, the film 401 of grafted silsesquioxane formed on the substrate 201 is patterned, to form a pattern different in chemical properties from the film 401 of grafted silsesquioxane in such a way to correspond to the arrangement of the microdomains 203 distributed in the continuous phase in the polymer thin film M, shown in FIG. 1. The patterning is described in more detail later.

Known drawing methods, e.g., lithography and that using electron beams (EB), may be used in accordance with the desired pattern size.

Here, the patterning by photolithography is described. The resist film 402 is formed on the film 401 of grafted silsesquioxane (refer to FIG. 2 (b)).

Next, the resist film 402 is exposed to light to be patterned (refer to FIG. 2 (c)), and developed to serve as the masks (refer to FIG. 2 (d)).

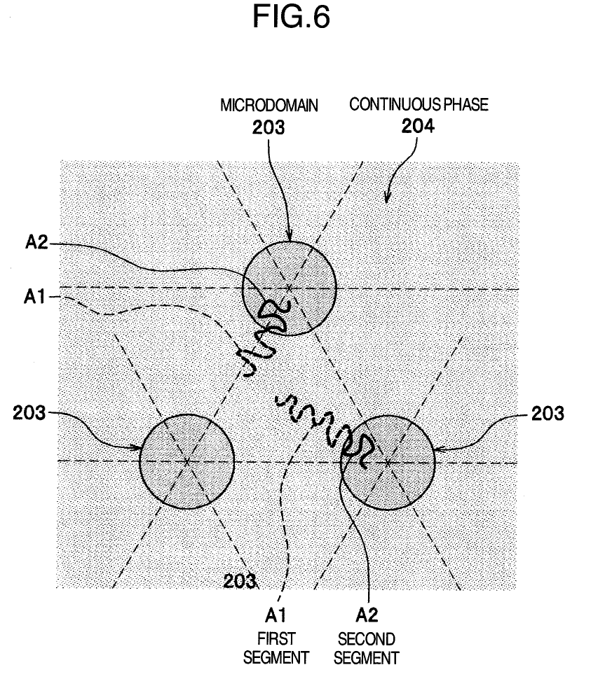

The film 401 of grafted silsesquioxane is partially oxidized with an oxygen plasma or the like via the masks of the patterned resist film 402 (refer to FIG. 2 (e)). In other words, the substrate 201 surface is divided into the first regions 106 and second regions 107, the former comprising the film 401 of grafted silsesquioxane and the latter comprising the oxidized film 401a of grafted silsesquioxane. Thus, these regions are formed to be different from each other in chemical properties. In this embodiment, the component of the second segment A2 (refer to FIG. 6) component of the block copolymer, described later, as the material for forming the polymer thin film M (refer to FIG. 1) is made more wettable with the second region 17 than with the first region 106.

The second region 107 corresponds to the “pattern” described in claim 1. The process for forming the first region 106 and second region 107 on the substrate 201 corresponds to the “step for forming a pattern” described in claim 1.

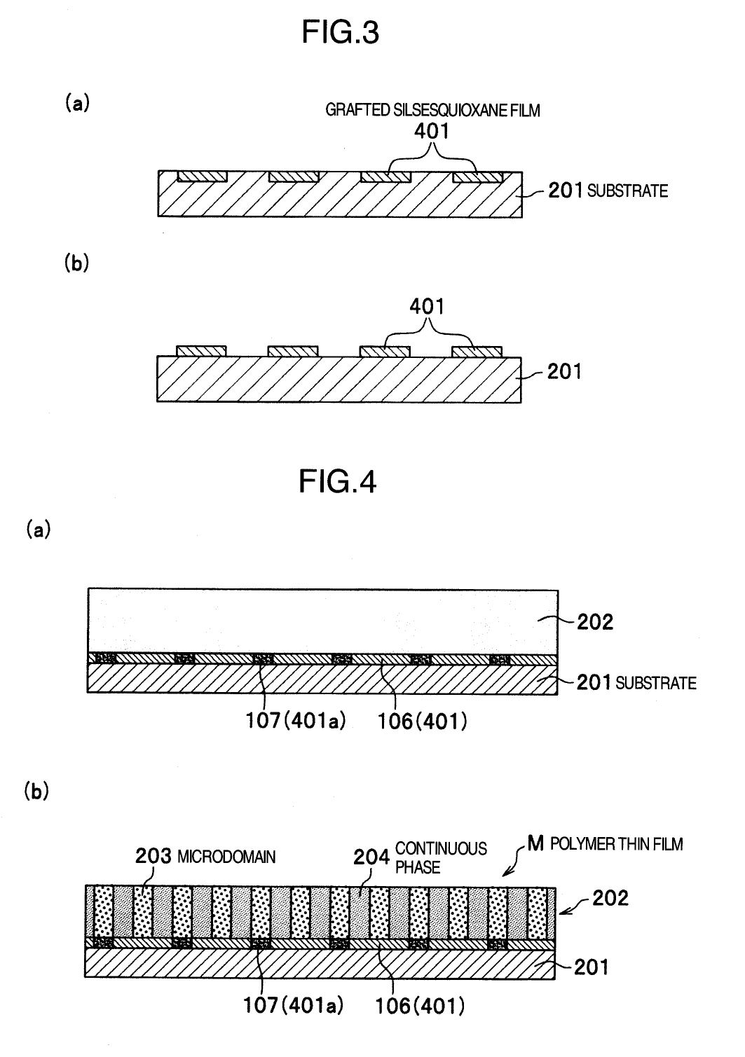

The first region 106 comprising the film 401 of grafted silsesquioxane and the second region 107 comprising the oxidized film 401a of grafted silsesquioxane are formed by the above process as the thin films on the substrate 201 (refer to FIG. 2 (f)). However, formation of these films is not limited for the present invention. FIGS. 3 (a) and (b) illustrates other processes for forming the film 401 of grafted silsesquioxane.

The film 401 of grafted silsesquioxane may be embedded discretely in the substrate 201 (refer to FIG. 3 (a)), or disposed discretely on the substrate 201 (refer to FIG. 3 (b)). Moreover, the embodiments illustrated in FIGS. 3 (a) and (b) may use the oxidized film 401 of grafted silsesquioxane (not shown) in place of the film 401 of grafted silsesquioxane.

The above-described method produces the polymer thin film M of the present invention (refer to FIG. 1) by microphase separation of the block copolymer, described later, on the substrate 201 surface coated with the patterned film 401 of grafted silsesquioxane. FIGS. 4 (a) and (b) illustrates a process for producing the polymer thin film in one embodiment of the present invention.

The method forms the coating film 202 of the block copolymer, described later, on the film 401 of grafted silsesquioxane on which the first regions 106 and second regions 107 are formed. The coating film 202 corresponds to the “polymer layer” described in claims, and the process for forming the coating film 202 corresponds to the “first step” described in claim 1.

The coating film 202 may be formed by spreading a dilute solution with the block copolymer dissolved in a solvent on the film 401 of grafted silsesquioxane by spin coating, dip coating or the like.

When spin coating is adopted, the coating film 202 having a thickness of about several tens of nanometers (dry basis) can be stably formed under the conditions of solution concentration set at several % by mass and rotational speed of 1,000 to 5,000 rpm.

The block copolymer for the coating film 202 may not be sufficiently microphase-separated, because of rapid evaporation of the solvent during the film-making process, and is frequently in a non-equilibrium or completely disordered state. The structure is generally in a non-equilibrium state, although depending on the film-making process adopted.

It is therefore desirable to anneal the coating film 202 to allow the microphase separation to proceed sufficiently and secure the equilibrium structure. The annealing procedures useful for the present invention include thermal annealing in which the coating film is heated to a glass transition temperature of the block copolymer or higher, and solvent annealing in which the coating film 202 is exposed to the vapor of good solvent for the block copolymer for several hours.

Of these procedures, the solvent annealing is more preferable for the microphase separation of the block copolymer. In particular, when the block copolymer comprises polymethylmethaxcrylate having a silsesquioxane skeleton, described later, the solvent is preferably carbon disulfide. The solvents useful for the present invention may be acetone, tetrahydrofuran, toluene, chloroform and so on in addition to carbon disulfide.

The production method produces the microstructures with a plurality of the columnar microdomains 203, containing the second segment A2 component, described later (refer to FIG. 6), regularly arranged on the substrate 201 in the in-plane direction in the continuous phase containing the first segment A1 component of the block copolymer (refer to FIG. 6) by microphase separation of the coating film 202 (of polymer) on the film 401 of grafted silsesquioxane (refer to FIG. 4 (b)). This process corresponds to the “second step” described in claim 1.

The second segment A2 component (refer to FIG. 6) in the second region 107 is more wettable than the first segment A1 component (also refer to FIG. 6) in the first region 106.

The first segment A1 component (refer to FIG. 6) in the first region 106 is more wettable than the second segment A2 component (also refer to FIG. 6) in the first region 106. In other words, the microdomains 203 has a lower interfacial tension with the second region 107 than with the first region 106, and the continuous phase 204 has a higher interfacial tension with the second region 107 than with the first region 106.

The columnar microdomains 203 containing the second segment A2 component (refer to FIG. 6) are formed on the second regions 107, and the continuous phase 204 containing the first segment A1 component (refer to FIG. 6) is formed on the first regions 106 (refer to FIG. 4 (b) by the chemical registration which forms the first regions 106 and second regions 107, different in chemical properties from each other, on the substrate 201.

The microdomains 203 formed on the first regions 106 (refer to FIG. 4 (b)) are interpolated, as discussed later.

The chemical registration used in the embodiment of the present invention is described in more detail.

The chemical registration is a method for improving the long-distance regularity of the microphase-separated structure formed by self-assembly of the block copolymer by, for example, the chemical marks formed on the substrate 201, more specifically by the second regions 107 (pattern), each being disposed between the adjacent first regions 106, as illustrated in FIG. 2 (f). This method complements defects in the second regions 107 as the chemical marks by self-assembly of the block copolymer.

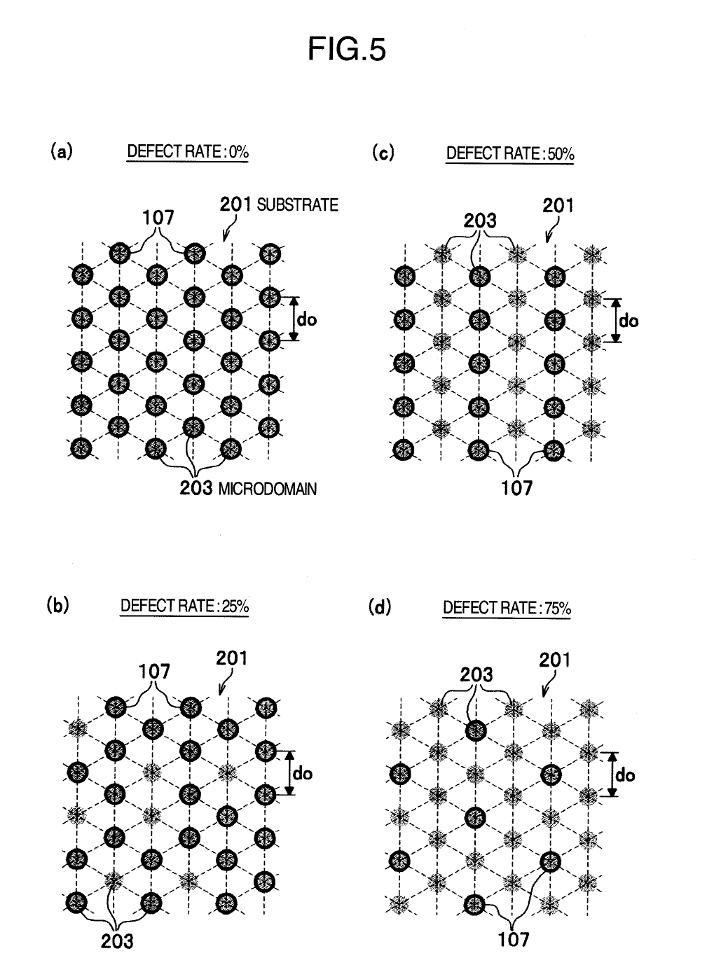

The representative examples of the pattern produced by the chemical registration are described, wherein the second regions 107 as the chemical marks can be complemented. FIG. 5 (a) is a conceptual view illustrating the microphase-separated block copolymer, with the second regions as the chemical marks arranged on the entire substrate surface at intervals of natural period (d₀, hexagonal natural period, refer to FIG. 1) of the block copolymer. FIG. 5 (b) is a conceptual view illustrating the microphase-separated block copolymer, with the second regions as the chemical marks arranged to have a defect rate of 25%. FIG. 5 (c) is a conceptual view illustrating a microphase-separated block copolymer, with the second regions as chemical marks arranged to have a defect rate of 50%. FIG. 5 (d) is a conceptual view illustrating a microphase-separated block copolymer, with the second regions as chemical marks arranged to have a defect rate of 75%.

When the second regions are hexagonally arranged on the substrate 201 (refer to FIGS. 5 (a), defect ratio of the marks: 0%), the block copolymer for this embodiment is microphase-separated to have the microdomains 203 upstanding at the positions corresponding to the second regions 107 at intervals of the hexagonal natural period d₀.

When the second regions as the chemical marks are arranged to have a defect ratio of 25% on the substrate 201 (refer to FIG. 5 (b), the block copolymer for this embodiment is microphase-separated to have the microdomains 203 upstanding at the positions corresponding to the defects in the second regions 107, because they are restricted by those upstanding around the defects. In other words, the defects in the second regions 107 are complemented when the block copolymer for this embodiment is used to accurately realize the chemical registration.

When the second regions as the chemical marks are arranged to have a defect ratio of 50% (pattern density: ½) on the substrate 201 (refer to FIG. 5 (c), more specifically with the second regions 107 arranged every second rows, the block copolymer for this embodiment is microphase-separated to have the microdomains 203 upstanding at the positions corresponding to the defects in the second regions 107, because they are restricted by those upstanding around the defects. In other words, the defects in the second regions 107 are complemented when the block copolymer for this embodiment is used to accurately realize the chemical registration.

When the second regions as the chemical marks are arranged to have a defect ratio of 75% (pattern density: ¼) on the substrate 201 (refer to FIG. 5 (d), more specifically with the second regions 107 arranged every third rows, the block copolymer for this embodiment is microphase-separated to have the microdomains 203 upstanding at the positions corresponding to the defects in the second regions 107, because they are restricted by those upstanding around the defects, although the restriction force is reduced. In other words, the defects in the second regions 107 are complemented when the block copolymer for this embodiment is used to accurately realize the chemical registration.

As discussed above, the period (lattice-lattice distance) between the adjacent second regions 107 as the chemical marks is preferably an integral multiple of the natural period of the polymer thin film to form the pattern.

Next, the surface modifying agent and block copolymer for production of the polymer thin film M of the present invention are described.

### (Surface Modifying Agent)

The surface modifying agent is a polymer which can form the film 401 of grafted silsesquioxane (refer to FIG. 2 (a)) on the substrate 201 (refer to FIG. 2 (a)), as described earlier. It contains a divalent organic group having a functional group capable of coupling to the hydroxide group present on the substrate 201 surface and a polymer chain having, in the side chain, a monovalent functional group containing a polyhedral oligomeric silsesquioxane skeleton. The polymer compounds represented by the following formula (1) are particularly preferable for the surface modifying agent.

I-D-P-T (1)

(wherein, I is an alkyl group, D is 1,1-diphenylethylene as the divalent organic group having a functional group capable of coupling to the hydroxide group present on the substrate surface, P is polymethacrylate as the polymer chain having, in the side chain, a monovalent functional group containing a polyhedral oligomeric silsesquioxane (POSS) skeleton (hereinafter sometimes referred to as POSS-containing PMA), and T is an alkyl group.

The alkyl group represented by I in the formula (1) is that used for synthesis of the surface modifying agent, and more specifically it is derived from a reaction initiator for living anion polymerization. Sec-butyl is particularly preferable alkyl group.

Examples of the functional group for accelerating coupling of 1,1-diphenylethylene, represented by D in the formula (1), include hydroxide, amino, carboxyl, silanol, and hydrolysable silyl (e.g., alkoxysiyl and halogenated silyl).

Examples of the particularly preferable divalent 1,1-diphenylethylene include those represented by the following structural formulae:

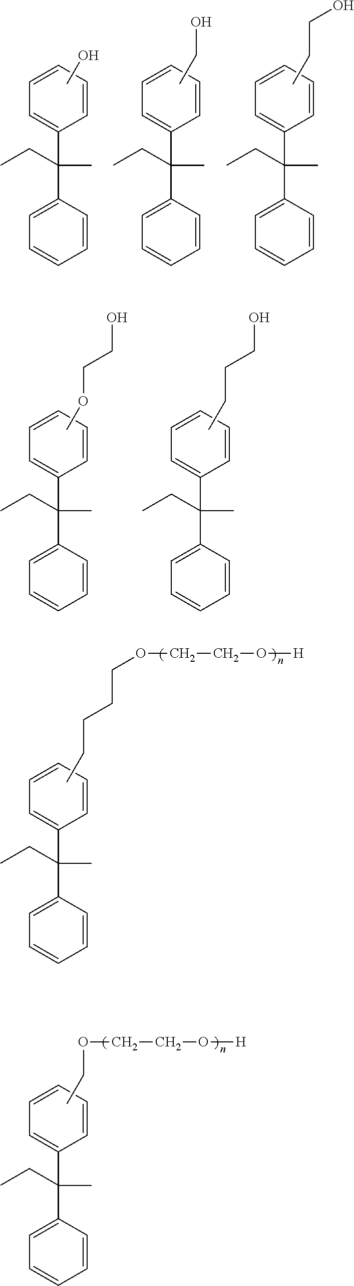

(wherein, “n” is individually an integer of 1 to 10).

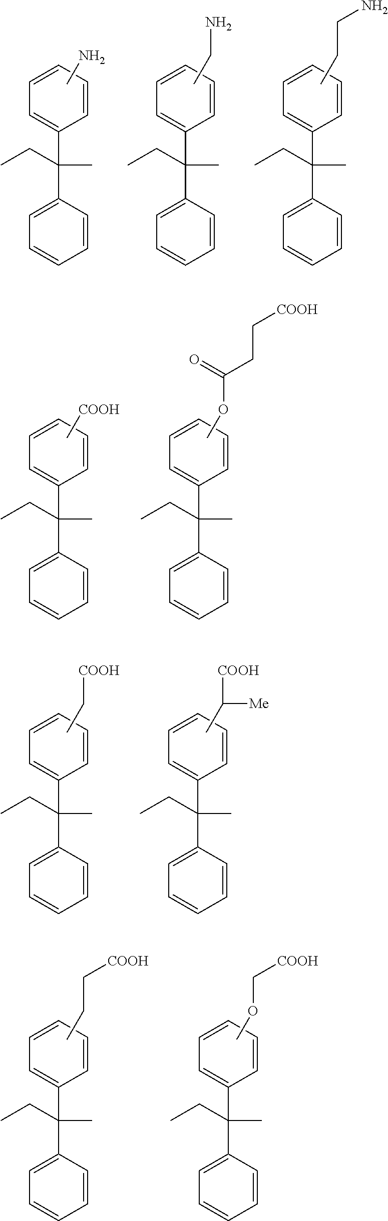

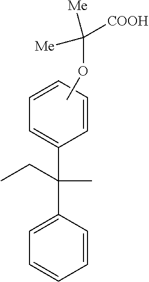

(wherein, Me in the above structural formulae is methyl group).

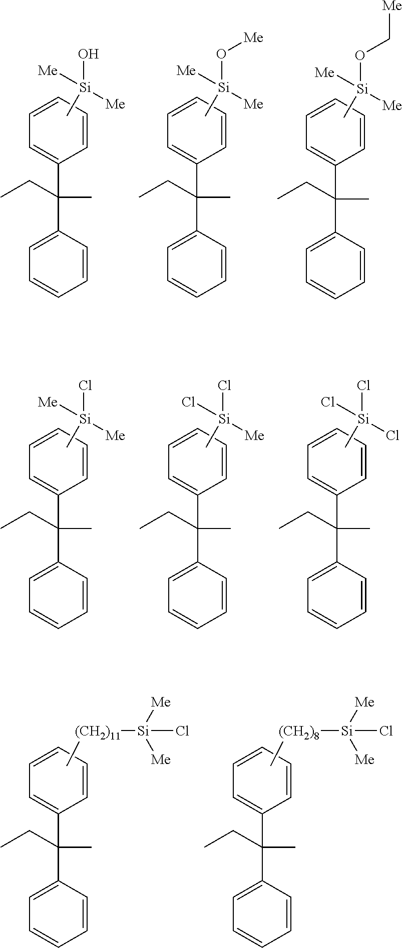

(wherein, Me in the above structural formulae is methyl group).

Examples of the POSS-containing PMA, represented by P in the formula (1), include those represented by the following structural formula (2):

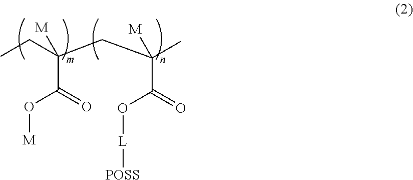

(wherein, “m” is an integer of 0 or more, “n” is an integer of 1 to 70 μL is a divalent organic group as a linker, M is individually hydrogen atom or an alkyl or aryl group of 1 to 2 carbon atoms, and POSS is polyhedral oligomeric silsesquioxane).

The organic group serving as a linker is not limited so long as it can introduce POSS in the side chain of PMA. Examples of the organic group include alkyl, aryl, ester and amide of 1 to 24 carbon atoms.

Examples of the polyhedral oligomeric silsesquioxane (POSS) are preferably those represented by the following structural formulae, wherein R is a functional group selected from the group consisting of methyl, ethyl, isobutyl, cyclopentyl, cyclohexyl, phenyl and isooctyl. These groups in the same structure may be the same or different.

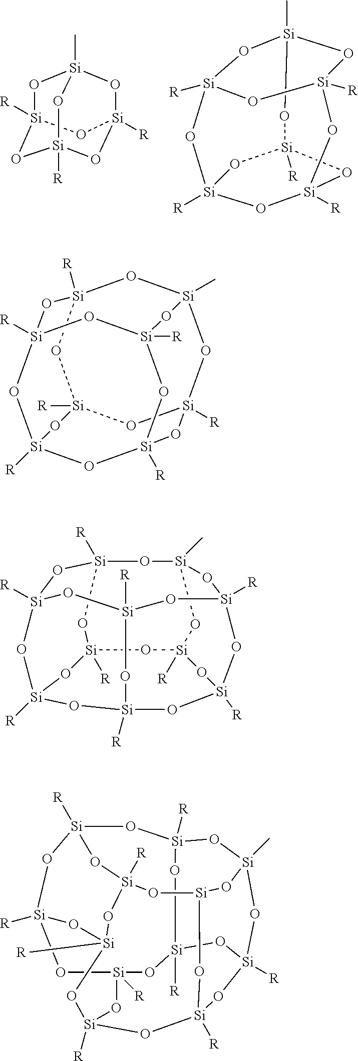

The alkyl group represented by T in the formula (1) is that used for synthesis of the surface modifying agent, and more specifically it is derived from a reaction terminator for living anion polymerization. Methyl is particularly preferable alkyl group.

The polymer compounds represented by the following formula (3) may be used for synthesis of the surface modifying agent in this embodiment:

I-P-D-T (3)

(wherein, I, P, D and T are each the same as those in the formula (1)).

Examples of the surface modifying agent produced in this embodiment include, in addition to those represented by the formulae (1) and (3), polymer compounds synthesized by randomly reacting monomers having a functional group coupling to the hydroxide group present on the substrate 201 (refer to FIG. 2 (a)) with the PASS-containing PMA.

Examples of these monomers include those represented by the following structural formulae.

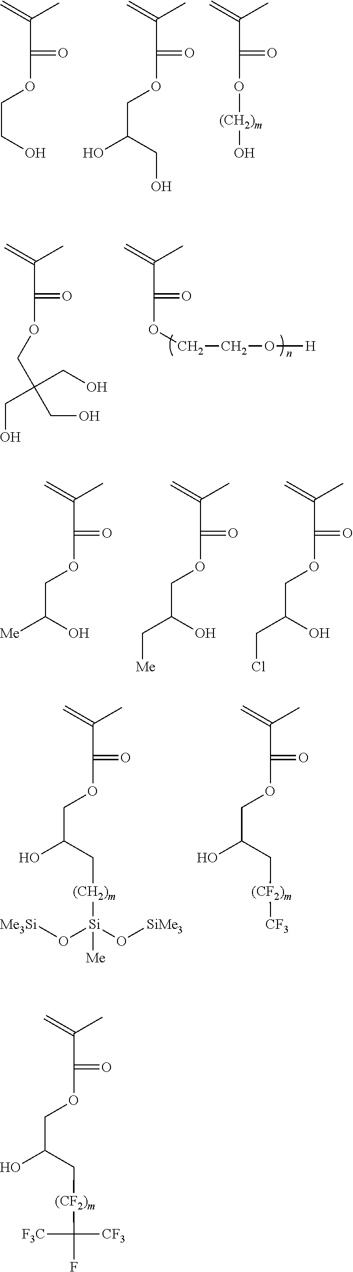

(wherein, “m” is individually an integer of 1 to 24, “n” is an integer of 1 to 10, and Me is methyl group).

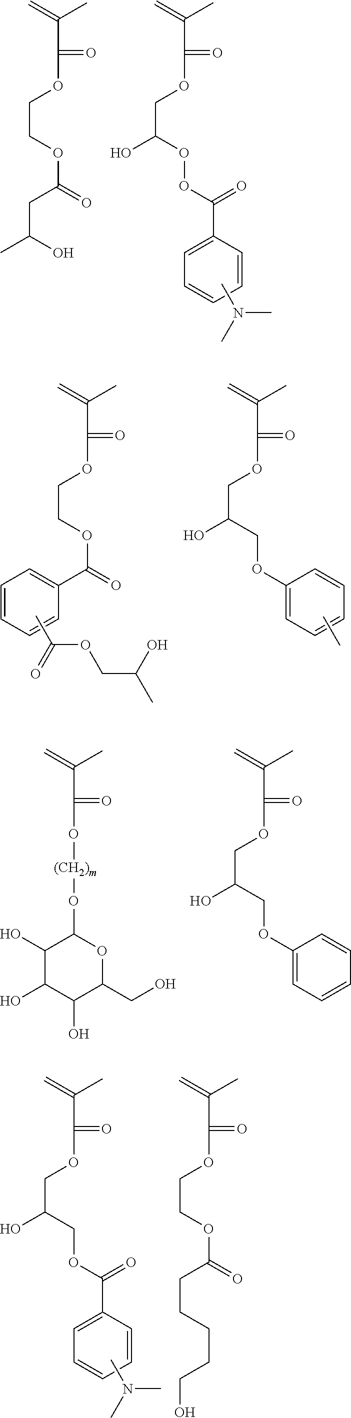

(wherein, “m” is an integer of 1 to 24).

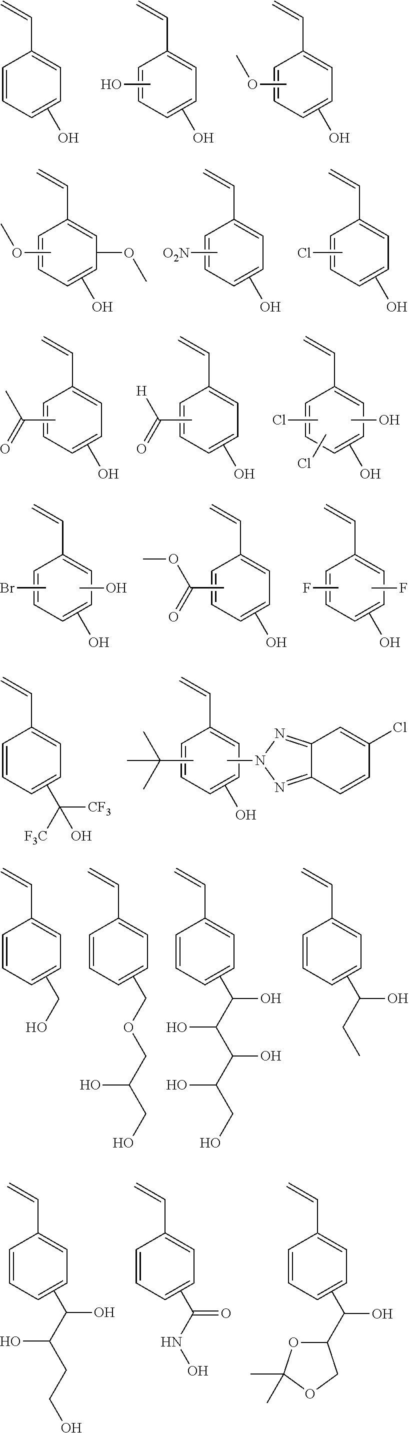

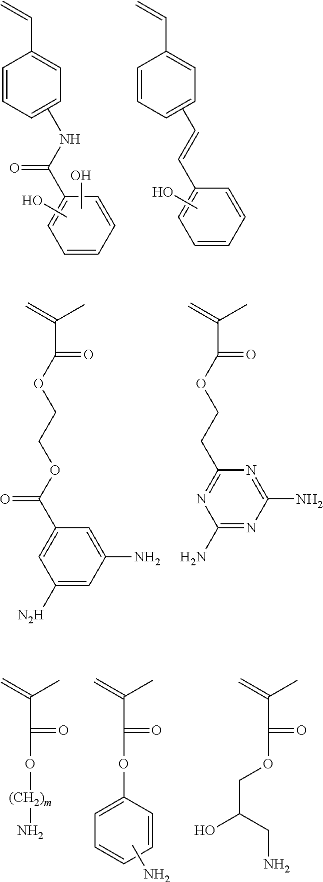

(wherein, “m” is an integer of 1 to 24).

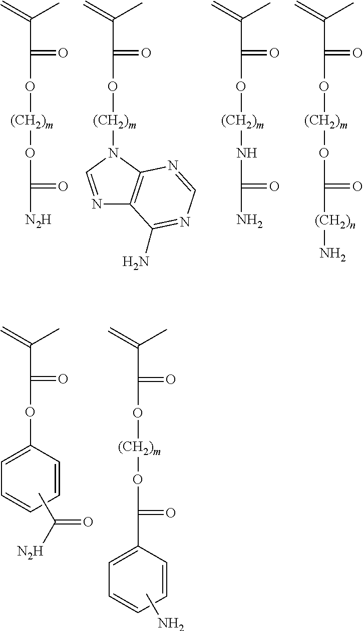

(wherein, “m” is individually an integer of 1 to 24, and “n” is an integer of 1 to 24).

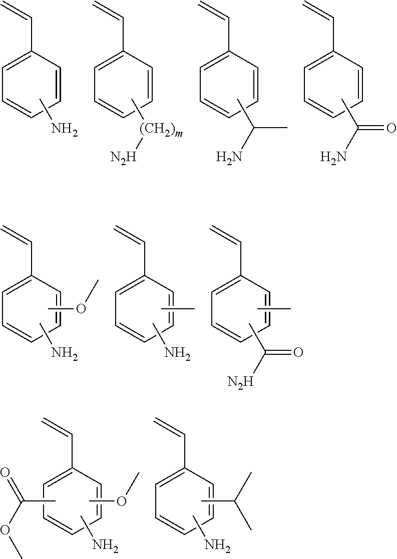

(wherein, “m” is an integer of 1 to 24).

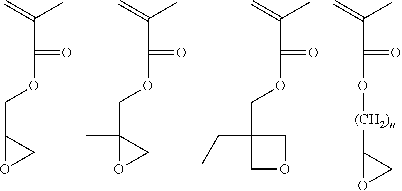

(wherein, “n” is an integer of 1 to 24).

Examples of the surface modifying agent related to this embodiment are described. The surface modifying agent of the present invention may be produced by various polymerization processes, including atomic-transfer radical, reversible addition/fragmentation chain-transfer, nitroxide-mediated and ring-opening methathesis polymerization processes, in addition to living anion process.

### (Block Copolymer)

The block copolymer used for producing the polymer thin film of the present invention is microphase-separated on the substrate 201 to form the continuous phase 204 and microdomains 203 (refer to FIG. 1). FIG. 6 is a conceptual view illustrating the first and second segments in the block copolymer used for producing the polymer thin film of the present invention, and corresponds to the partial plan view of the polymer thin film illustrated in FIG. 1.

The block copolymer in this embodiment comprises the first component for forming the continuous phase 204, and second segment A2 component for forming the microdomains 203.

It is preferable that the first segment A1 has a larger volumetric ratio than the second segment A2 in the block copolymer disposed on the substrate 201 (refer to FIG. 1).

The first segment A1 and second segment A2 volumes may be adjusted by changing polymerization extent of the polymer chains that constitute these segments.

The interface between the continuous phase 204 and microdomain 203 is determined in the vicinity of the bond between these segments. Therefore, the block copolymer preferably has a narrow molecular weight distribution. The block copolymer is more preferably produced by living anion polymerization.

The block copolymer in this embodiment preferably has a large interaction parameter. Examples of the preferable block copolymer include those containing POSS, PS-b-polydimethylsiloxane (PDMS) or PS-b-polyethylene oxide, of which POSS-containing one is more preferable.

Examples of POSS-containing block copolymer include those having a polymer chain represented by the following structural formula (4).

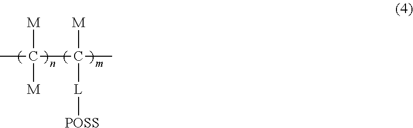

(wherein, M, L and POSS in the structural formula (4) are each the same as those in the formula (1)).

Each of the M, L and POSS in the same structure may be the same or different, and “m” and “n” in the structural formula (4) are an integer of 1 to 500 and 1 to 70, respectively.

In the block copolymer containing POSS having the polymer chain represented by the structural formula (4), the block containing POSS corresponds to the first segment A1 (refer to FIG. 6) and block containing no POSS corresponds to the second segment A2 (refer to FIG. 6).

The block copolymer in this embodiment has POSS in the side chain in one of the segment A1 block and segment A2 block (refer to FIG. 6).

Preferable examples of the block copolymer include, but not limited to, polymethylmethacrylate-block-poly3-(3,5,7,9,11,13,15-heptaisobutyl-pentacyclo[9.5.|^{3,9}.|5,15|^{7,13}]octacyloxan-1-yl)propylmethacrylate (hereinafter sometimes referred to as PMMA-b-PMAPOSS), polystyrene-block-poly3-(3,5,7,9,11,13,15-heptaisobutyl-pentacyclo[9.5.|^{3,9}.|5,15|^{7,13}]octacyloxan-1-yl)propylmethacrylate (hereinafter sometimes referred to as PS-b-PMAPOSS), and polyethylene-block-poly3-(3,5,7,9,11,13,15-heptaisobutyl-pentacyclo[9.5.|^{3,9}.|5,15|^{7,13}]octacyloxan-1-yl)propylmethacrylate (hereinafter sometimes referred to as PEO-b-PMAPOSS). It is needless to say that the useful block copolymers include those having POSS in the side chain in a segment other than that described above.

More specifically, those having the structure shown in the formula (5), when taking PMMA-b-PMAPOSS as an example, are also useful.

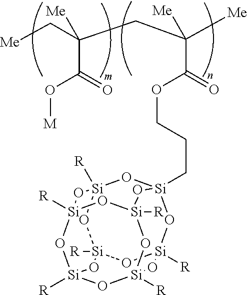

(wherein, R is isobutyl, Me is methyl, “m” is an integer of 1 to 500 and “n” is an integer of 1 to 70).

The block copolymer in this embodiment may be synthesized by an adequately selected polymerization process. It is however preferably synthesized by living anion polymerization, which can give the block copolymer having an as narrow a molecular weight distribution as possible to improve regularity of the microphase-separated structure.

The block copolymer taken as the example is of AB type with the first segment A1 and second segment A2 bonded to each other at the terminals (refer to FIG. 6). Other examples of the block copolymer useful for the present invention include linear and star-shape ones, e.g., ABA type triblock copolymers and ABC type copolymers having 3 or more species of polymer segments.

### (Patterned Media)

Next, the patterned media produced using the polymer thin film M is described. FIGS. 7 (a) to (f) illustrates the process for producing the patterned media using the polymer thin film M, where the patterned substrate 201 surface is not described. The patterned media described hereinafter means that having a concavo-convex surface corresponding to the regular pattern produced by the microphase separation.

This process produces the polymer thin film M having the microphase-separated structure comprising the continuous phase 204 and columnar microdomains 203 (refer to FIG. 7 (a)), wherein the continuous phase 204 and columnar microdomains 203 are supported by the substrate 201.

This process removes the microdomains 203 from the polymer thin film M (refer to FIG. 7 (b)) to produce the patterned media 21 as the porous thin film D with a plurality of the regularly arranged pores H.

The invention may remove the continuous phase 204 in place of the microdomains 203. In this case, the patterned media has a plurality of the regularly arranged columns, although not shown.

The continuous phase 204 or columnar microdomains 203 may be removed from the polymer thin film M by etching, e.g., reactive ion etching (RIE), which utilizes differential etching rate between them.

It is possible to improve etching selectivity by doping the continuous phase 204 or columnar microdomains 203 with atomic metal or the like.

The patterned media 21 may be produced by etching the substrate 201, after the continuous phase 204 or columnar microdomains 203 is/are removed, with the remaining one serving as the mask.

FIG. 7 (b) illustrates the case in which the columnar microdomains 203 are removed, and the substrate 201 is etched by RIE or plasma etching with the remaining continuous phase 204 as the polymer layer (porous thin film) serving as the mask. The etching gives the substrate 201 having the patterned surface corresponding to the polymer layer portions removed via the fine pores H (refer to FIG. 7 (c)). Thus, the pattern of the microphase-separated structure is transferred to the substrate 201 surface. Removing the porous thin film D remaining on the substrate 201 by RIE or with the aid of a solvent gives the patterned media 21a having the fine pores H patterned to correspond to the pattern of the columnar microdomains 203 (refer to FIG. 7 (d)).

The patterned media 21 may be used as the original plate to produce the replicas with the transferred pattern.

More specifically, the patterned media 21 with the porous thin film D (refer to FIG. 7 (b)) is pressed to an object 30 to transfer the pattern of the microphase-separated structure to the object 30 (refer to FIG. 7 (e)). Separating the patterned object 30 from the patterned media 21 (refer to FIG. 7 (e)) gives the replica (patterned media 21b) with the transferred pattern of the porous thin film D (refer to FIG. 7 (e)). FIG. 7 (f) illustrates this step.

The material for the object 30 may be selected from metals, e.g., nickel, platinum and gold, and inorganic materials, e.g., glass and titania, depending on the purposes. When the object 30 is of a metal, it can be pressed to the concavo-convex surface of the patterned media by sputtering, vapor deposition, plating or a combination thereof

When the object 30 is of an inorganic material, it can be pressed to the patterned media by a sol-gel process, in addition to sputtering or CVD.

The plating or sol-gel process is preferable, because it can accurately transfer the regularly arranged pattern of several tens of nanometers by a non-vacuum process, which can reduce the production cost.

The patterned media 21, 21a or 2b can find various applicable areas, because it has a fine patterned concavo-convex surface structure having a high aspect ratio.

For example, the patterned media 21, 21a or 21b can be used for massively producing the replicas having the same regularly arranged surface pattern, when it is repeatedly pressed to objects by nano-imprinting or the like.

Next, methods for transferring the fine concavo-convex surface pattern of the patterned media 21, 21a or 2b to the object 30 by nano-imprinting are described.

One method directly imprints the regular pattern accurately transferred from the patterned media 21, 21a or 2b (this method is referred to as thermo-imprinting). This method is suitable for the case in which the object 30 is of a material which can be directly imprinted. For example, when the object is of a thermoplastic resin, represented by polystyrene, the patterned media 21, 21a or 2b is pressed to the object 30 heated to glass transition temperature or higher, and then released from the object 30 after it is cooled to below glass transition temperature, to produce the replica.

Another method uses a photo-setting resin for the object 30 (not shown), when the patterned media 21, 21a or 2b is of a light-transmittable material, e.g., glass (this method is referred to as photo-imprinting). The photo-setting resin is hardened when irradiated with light, after being pressed to the patterned media 21, 21a or 2b, and the hardened resin is released from the patterned media. It may be used as the replica.

Another embodiment of photo-imprinting uses a substrate of glass or the like as the object 30 (not shown), irradiates a photo-setting resin with light after it is tightly placed between the patterned media and substrate, and releases the patterned media. It etches the substrate with a plasma, ion beams or the like with the hardened resin having the concavo-convex surface as the mask for transferring the regular pattern onto the substrate.

The polymer thin film, method for producing the patterned media and surface modifying agent of the present invention can give the microstructure having a finer structure than those produced by the conventional methods, regularity over a wide range and reduced amount of defects.

The present invention is not limited to the embodiments described above, and can be carried out by various embodiments. The embodiments described above take the polymer thin film M having the columnar microdomains 203 as the example. However, the microdomains 203 may be spherical or lamellar (layered).

The polymer thin film M can have the microdomains 203 of changed shape by adjusting polymerization degree during the microphase separation process to adjust the volumetric ratio of the first segment A1 component to the second segment A2 component on the substrate 201 (refer to FIG. 6). More specifically, the microdomains 203 containing the second segment A2 component (refer to FIG. 6) change from regularly arranged spherical shape to columnar shape and then to lamellar shape as the segment A2 component concentration increases from 0 to 50%.

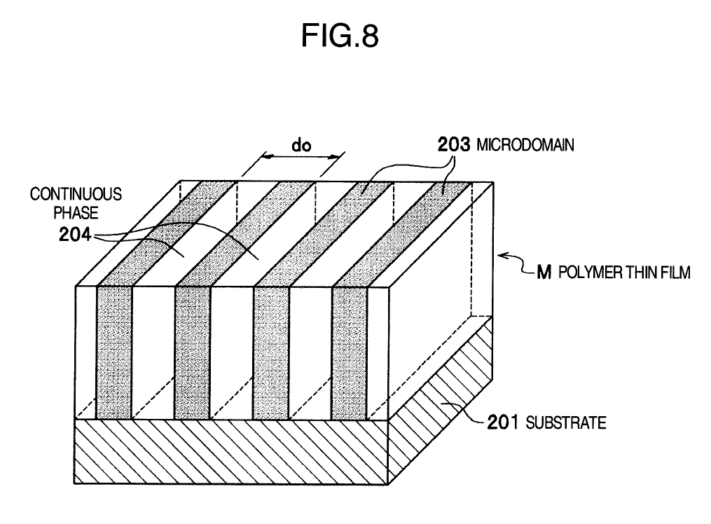

FIG. 8 is an oblique view illustrating the block copolymer microphase-separated to have a lamellar structure.

As illustrated in FIG. 8, the lamellar microphase-separated structure on the substrate 201 has the lamellar microdomains 203, containing the first segment A1 component (refer to FIG. 6), arranged at regular intervals in the continuous phase 204.

The symbol d₀ shown in FIG. 8 represents a natural period of the block copolymer, and the pattern of the grafted silsesquioxane film disposed on the substrate 201 has stripes arranged at regular intervals to correspond to the microdomains 203 and continuous phase 204.

The microstructures of the polymer thin film M, pattern media 21, 21a and 2b, replicas thereof and so on are applicable to information-recording media, e.g., magnetically recording and optically recording media. They are also applicable to parts for large-scale integrated circuits, lenses, polarization plates, wavelength filters, light-emitting elements, optical parts for integrated optical circuits and the like, immune assays, DNA separation, bio-devices, e.g., those for cell culturing and the like.

### EXAMPLES

Next, the present invention is described in more detail by referring to Examples.

### Example 1

### Measurement of Natural Period d₀ of Block Copolymer

Example 1 first prepared the block copolymer for forming the polymer thin film.

More specifically, the copolymer of polymethylmethacrylate-block-poly3-(3,5,7,9,11,13,15-heptaisobutyl-pentacyclo[9.5.|^{3,9}.|5,15|^{7,13}]octacyloxan-1-yl)propylmethacrylate (PMMA-b-PMAPOSS) was prepared, wherein the PMMA segment corresponding to the second segment A2 (refer to FIG. 6) had a number-average molecular weight Mn of 4,100, and PMAPOSS segment corresponding to the first segment A1 (refer to FIG. 6) had a number-average molecular weight Mn of 26,900.

The copolymer was referred to as the “first” block copolymer “PMMA(4.1 k)-b-PMAPOSS (26.9 k),” as shown in Table 1. The first block copolymer had a polydisperse index Mw/Mn of the overall molecular weight distribution of 1.03, by which was meant that the copolymer was microphase-separated into the columnar microdomains 203 of PMMA and continuous phase of the PMAPOSS.

TABLE 1

| | | | Number- | | | | | |
|---|---|---|---|---|---|---|---|---|
| | | | average | | | | Arranged conditions | |
| | Block | Surface | molecular | | Film | Contact | of microdomains | |
| | copolymer | modifying agent | weight (Mn) | Grafted film | thickness | angle | d/dₒ = 1 | d/dₒ = 2 |
| Example 1 | First | POSS- | 16900 | Grafted | 3.9 nm | 66° | ∘ | ∘ |
| | | containing PMA | | silsesquioxane | | | | |
| | | | | film | | | | |
| Example 2 | Second | ↑ | ↑ | ↑ | ↑ | ↑ | ∘ | ∘ |
| Comparative | First | Hydroxide- | 900 | Grafted | 1.7 nm | 32° | x | x |
| Example 1 | | incorporated PS | | polystyrene film | | | | |
| Comparative | First | ↑ | 3700 | ↑ | 5.1 nm | 27° | x | x |
| Example 2 | | | | | | | | |
| Comparative | First | ↑ | 10000 | ↑ | 8.7 nm | 18° | x | x |
| Example 3 | | | | | | | | |
| Comparative | Second | ↑ | 900 | ↑ | 1.7 nm | 32° | x | x |
| Example 4 | | | | | | | | |
| Comparative | Second | ↑ | 3700 | ↑ | 5.1 nm | 27° | x | x |
| Example 5 | | | | | | | | |
| Comparative | Second | ↑ | 10000 | ↑ | 8.7 nm | 18° | x | x |
| Example 6 | | | | | | | | |

First block copolymer: PMMA(4.1 k)-b-PMAPOSS (26.9 k), natural period d₀: 24 nm
Second block copolymer: PMMA(4.9 k)-b-PMAPOSS (32.5 k), natural period d₀: 30 nm

For measurement of natural period d₀ of the copolymer, the copolymer was first dissolved in toluene to a concentration of 1.0% by mass, and the solution was spread on a Si wafer by a spin coater to have the 40 nm thick film.

Next, the film formed on the Si wafer was annealed in the vapor of carbon disulfide to have the self-assembled structure (microphase-separated structure) in an equilibrium state. The microphase-separated structure was observed by a scanning electron microscope (SEM, S4800 supplied by Hitachi, Ltd.).

The SEM observation was carried out at an acceleration voltage of 0.7 kV. The sample was prepared by the following procedure.

First, the PMMA microdomains present in the thin film of the copolymer were decomposed by oxygen-aided RIE and removed, to produce the polymer thin film having a nanometer-scale concavo-convex structure derived from the microphase-separated structure. RIE was carried out by a device (RIE-10NP, supplied by SAMCO, Inc.) under the conditions of oxygen partial pressure: 1.0 Pa, oxygen gas flow rate: 10 cm³/minute, power: 20 W and etching time: 30 seconds.

In order to accurately measure the microstructure, the sample was not coated with deposited Pt or the like (coating of the sample is normally followed for antistatic purposes), and acceleration voltage was adjusted to secure a necessary contrast.

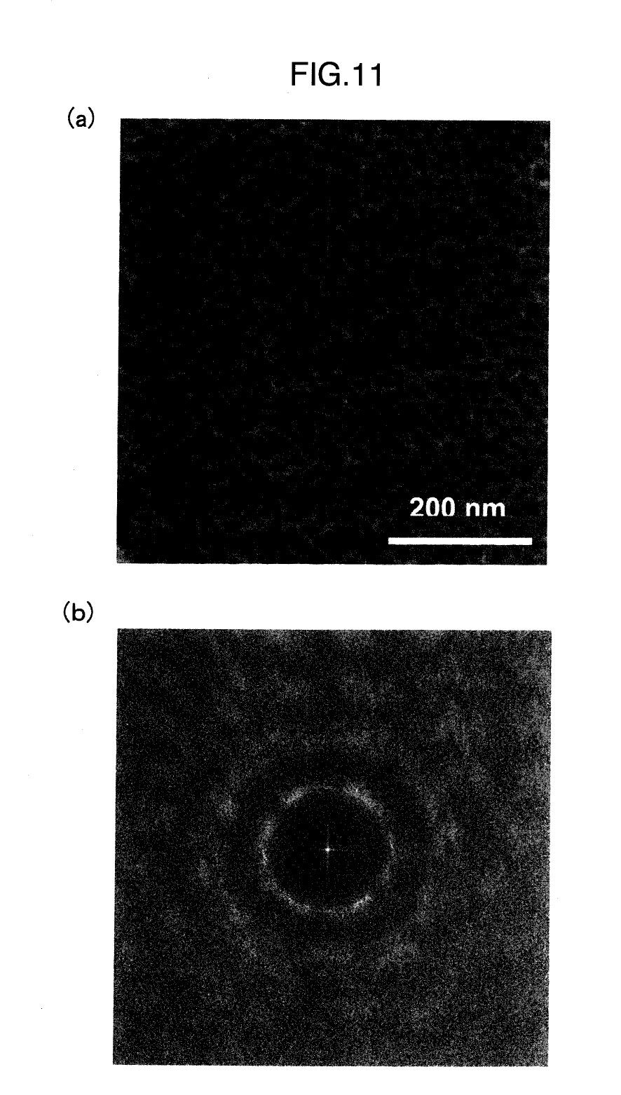

FIG. 11 (a) is an SEM image of the microphase-separated PMMA(4.1 k)-b-PMAPOSS (26.9 k), and FIG. 11 (b) is a two-dimensional Fourier conversion image of the arranged columnar microdomain.

As shown in FIG. 11 (a), the microphase-separated structure of the block copolymer had columnar microdomains upstanding on the Si wafer, many locally arranged hexagonally.

The SEM image was used to determine the natural period d₀ by two-dimensional Fourier conversion, where the SEM image was processed by a common image-processing software.

As shown in FIG. 11 (b), the two-dimensional Fourier conversion image with the columnar microdomains arranged on the Si wafer showed a halo pattern with a number of assembled spots, and the natural period d₀ was determined based on the primary halo radius. The natural period d₀ determined was 24 nm. It is shown in Table 1.

### (Formation of Grafted Silsesquioxane Film)

Next, this example prepared a grafted silsesquioxane film on the substrate. The substrate was 4-inch Si wafer coated with a naturally oxidized film. The substrate was washed with a piranha solution. A piranha solution having an oxidation function removed organics from the substrate surface, and oxidized the wafer surface to increase hydroxide group density on the surface. Next, a solution with a surface modifying agent of the polymer represented by the following structural formula dissolved in toluene was spread on the Si wafer by a spin coater (1H-360S, supplied by MIKASA Co.) at a rotational speed of 2,000 rpm.

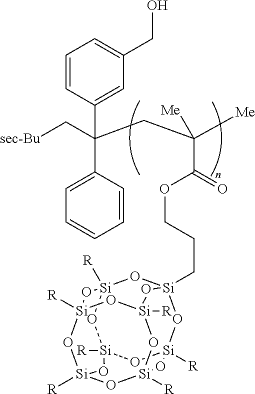

(wherein, sec-Bu is sec-butyl, Me is methyl, R is isobutyl and “n” is an integer of 1 to 70, and the surface modifying agent (polymer compound) had a number-average molecular weight Mn of 16,900 as polystyrene (PS)).

The coating film on the Si wafer was about 40 nm thick.

The surface modifying agent is referred to as “POSS-containing PMA” as shown in Table 1.

Next, the coated Si wafer was heated at 190° C. for 72 hours in a vacuum oven. This treatment caused dehydration by the reaction between the hydroxide group in the surface modifying agent and hydroxide group in the Si wafer to chemically bond the surface modifying agent and Si wafer to each other. The coated Si wafer was immersed in toluene and ultrasonically treated to remove the unreacted surface modifying agent. This formed the grafted silsesquioxane film on the wafer.

In order to evaluate the surface conditions of the grafted silsesquioxane film, measurements were made for film thickness, amount of carbon deposited on the film, and contact angle of homopolymethylmethacrylate (P4078, supplied by Polymer Source, Inc., molecular weight: 11,500, hereinafter referred to as hPMMA) with the grafted silsesquioxane film surface.

Thickness of the grafted silsesquioxane film was 3.9 nm, measured by spectral ellipsometry. The amount of carbon deposited on the film was measured by X-ray photoemission spectroscopy (XPS). The integral intensity of the peaks derived from its C1s was 12,000 cps. The integral intensity of the Si wafer before it was coated with the grafted silsesquioxane film was 1,200 cps.

The contact angle of the hPMMA with the grafted silsesquioxane film surface was measured by the following procedure. First, the grafted silsesquioxane film was coated with an hPMMA film (thickness: about 20 nm) by spin coating. Next, the coated film of grafted silsesquioxane was annealed at 170° C. under a vacuum for 72 hours. This treatment dewetted the hPMMA coating film on the grafted silsesquioxane film to form fine hPMMA droplets. The cross-sectional shape of the hPMMA droplet was observed by an atomic force microscope (AFM) to determine the contact angle of the hPMMA with the grafted silsesquioxane film surface. The measurement was made for 5 different points. The average contact angle was 66°. The contact angle of hPMMA with the Si wafer surface before it was coated with the grafted silsesquioxane film was 0°. This also confirmed that the grafted silsesquioxane film was formed on the Si wafer.

(Patterning of the Substrate Coated with the Grafted Silsesquioxane Film)

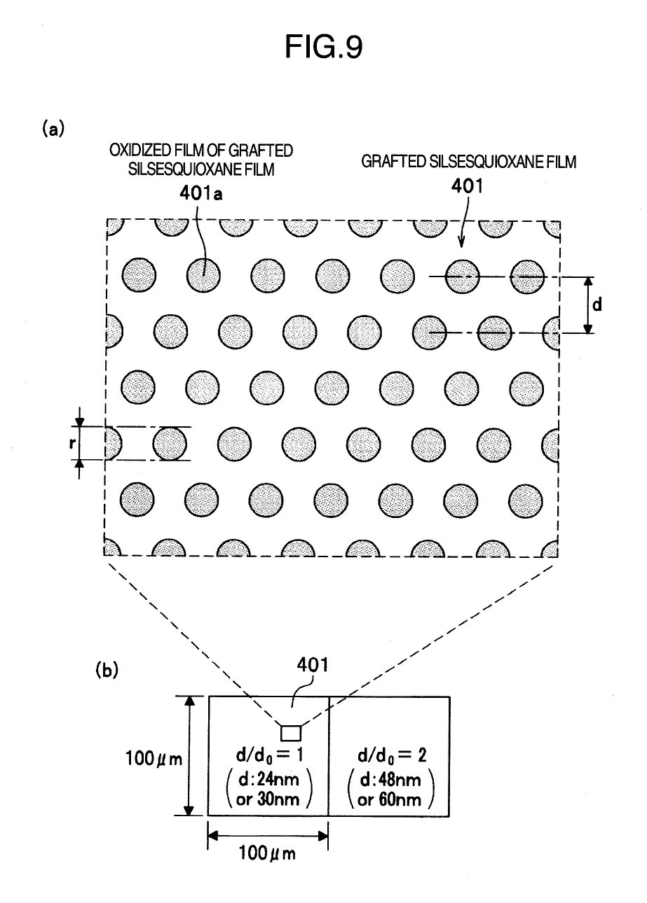

The Si wafer coated with the grafted silsesquioxane film was diced into 2 cm square samples, and the grafted silsesquioxane film was patterned by EB lithography. FIG. 9 (a) is a partially expanded plan view illustrating the grafted silsesquioxane film after it is patterned, and FIG. 9 (b) schematically illustrates the configuration of the regions of different lattice-lattice distance “d.”

As illustrated in FIG. 9 (a), the grafted silsesquioxane film 401 surface was patterned to have the circular regions (diameter: r) hexagonally arranged at the intervals of lattice-lattice distance d, formed by partial oxidation of the film surface. The region is hereinafter referred to as the oxidized film 401a of grafted silsesquioxane.

The grafted silsesquioxane film 401 surface was patterned to have 2 region types, 100 μm square, wherein the d/d₀ ratio was set at 1 (d: lattice-lattice distance, nm and d₀: natural period of the block copolymer, 24 nm) in one region, and at 2 in the other region (refer to FIG. 9 (b). In other words, one region had the lattice-lattice distance of 24 nm, and the other region had the distance of 48 nm. The circle diameter “r” in these regions was set at about 25 to 30% of the lattice-lattice distance “d.” However, the diameter is not limited, so long as the microphase-separated structure arrangement can be controlled by the chemical registration.

Next, the procedure for patterning the grafted silsesquioxane film 401 is described in more detail by referring to FIGS. 2 (b) to (f), as required.

The grafted silsesquioxane film 401 was coated with the 50 nm thick resist film 402 of polymethylmethacrylate by spin coating (refer to FIG. 2 (b)).

Next, the resist film 402 was exposed to light at an acceleration voltage of 100 kV by an EB drawing apparatus in such a way to correspond to the pattern, wherein the circle diameter “r” was adjusted by extent of exposure to EB (refer to FIG. 2 (c)). The resist film 402 was then developed (refer to FIG. 2 (d)).

Next, the grafted silsesquioxane film 401 was oxidized by oxygen-aided RIE with the patterned resist film 402 serving as the mask. The RIE was carried out by an ICP dry etching apparatus under the conditions of output: 20 W, oxygen partial pressure: 1 Pa, oxygen gas flow rate: 10 cm³/minute, and etching time: 5 to 20 seconds. This treatment produced the first region 106 of grafted silsesquioxane film 401 and second region 401a of oxidized film of grafted silsesquioxane (refer to FIG. 2 (e)).

The resist film 402 remaining on the substrate 201 was washed out by toluene, to produce the substrate 201 coated with the patterned film of grafted silsesquioxane (refer to FIG. 2 (f)).

(Comparison of the Grafted Silsesquioxane Film with the Oxidized Film in Wettability)

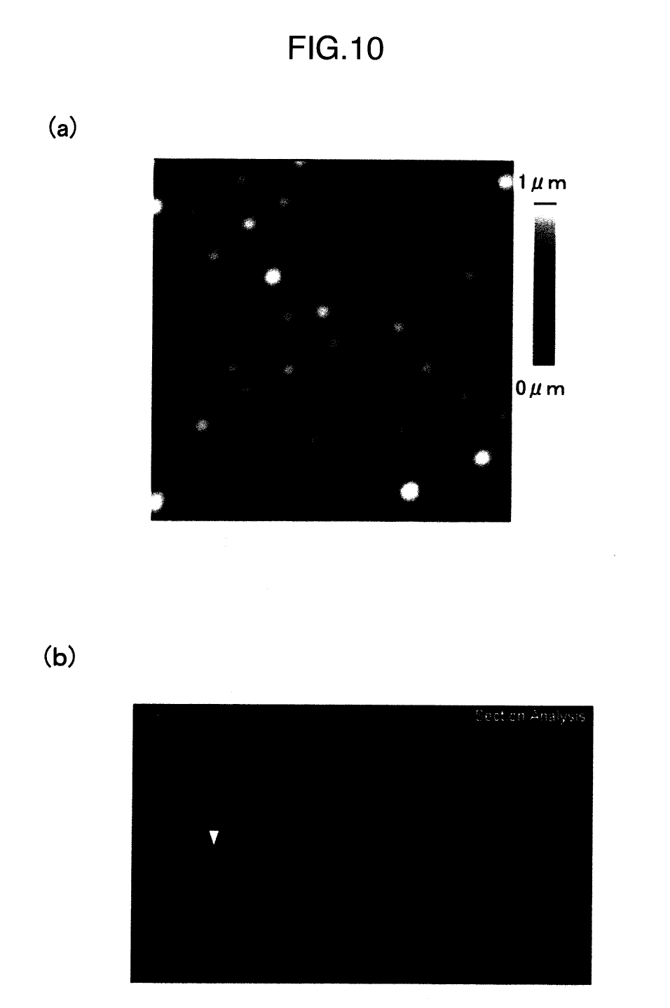

The contact angle of hPMMA with the grafted silsesquioxane film surface was measured by the procedure described earlier. It was 66°. FIG. 10 (a) is an AFM image illustrating the hPMMA liquid droplets on the grafted silsesquioxane film, and FIG. 10 (b) is a cross-sectional image illustrating the hPMMA liquid droplet on the grafted silsesquioxane film.

Next, the grafted silsesquioxane film was oxidized under the same conditions as those used for patterning, described earlier. The contact angle of hPMMA with the oxidized film surface was measured by the procedure described earlier. It was 0°. No hPMMA liquid droplet was observed on the oxidized film by an atomic force microscope (AFM).

### (Formation of the Polymer Thin Film by Chemical Registration)

The patterned film of grafted silsesquioxane was coated with a block copolymer film.

More specifically, the block copolymer film 202 was deposited on the substrate 201 patterned to have the first regions 106 of the grafted silsesquioxane film 401 and second regions 107 of the oxidized film 401a of grafted silsesquioxane (refer to FIG. 4 (a)).

Next, the block copolymer was microphase-separated by annealing in the vapor of carbon disulfide solvent for 3 hours. This treatment produced the columnar microdomains 203 of the PMMA segment, arranged while they were restricted by the second regions 107 of the oxidized film 401a, and continuous phase 204 of the PMAPOSS segment on the first regions 106 of the grafted silsesquioxane film 401 (refer to FIG. 4 (b)).

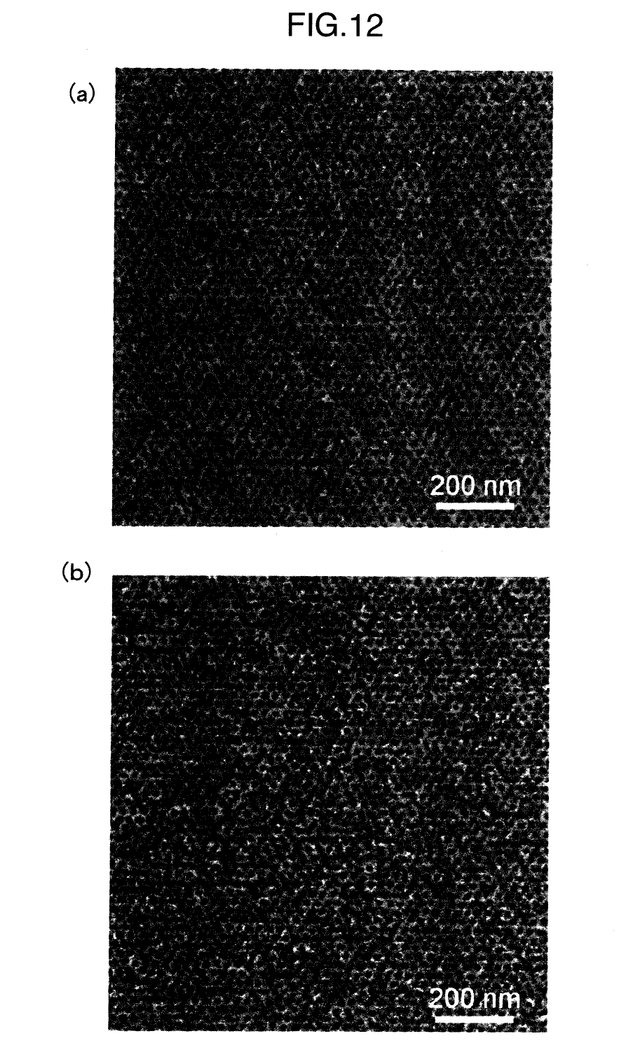

FIG. 12 (a) is an SEM image of the microdomains with the d/d₀ ratio set at 1 (d: lattice-lattice distance, nm and d₀: natural period of the block copolymer, 24 nm). As shown, the columnar microdomains were upstanding on the substrate and regularly arranged on the substrate in the in-plane direction over a long distance. Moreover, the columnar microdomains were upstanding on the substrate and regularly arranged on the substrate in the in-plane direction over a long distance even with the d/d₀ ratio set at 2.

The microdomains produced in this example were substantially free of defects and regularly arranged for a long period of time. Thus, the surface conditions of the grafted silsesquioxane film were evaluated good ‘◯’, as shown in Table 1.

### Example 2

Example 2 also used the block copolymer of polymethylmethacrylate-block-poly3-(3,5,7,9,11,13,15-heptaisobutyl-pentacyclo[9.5.|^{3,9}.|5,15|^{7,13}]octacyloxan-1-yl)propylmethacrylate (PMMA-b-PMAPOSS), wherein the PMMA segment corresponding to the second segment A2 (refer to FIG. 6) had a number-average molecular weight Mn of 4,900, and PMAPOSS segment corresponding to the first segment A1 (refer to FIG. 6) had a number-average molecular weight Mn of 32,500.

The block copolymer was referred to as the “second” block copolymer PMMA(4.9 k)-b-PMAPOSS (32.5 k) as shown in Table 1. The second block copolymer had a polydisperse index Mw/Mn of the overall molecular weight distribution of 1.03, by which was meant that the copolymer was microphase-separated into the columnar microdomains 203 of PMMA and continuous phase of the PMAPOSS.

The second block copolymer was measured for its natural period d₀ in the same manner as in Example 1. It was 30 nm.

This example patterned, as with Example 1, the grafted silsesquioxane film on the substrate to have 2 region types, wherein the d/d₀ ratio was set at 1 (d: lattice-lattice distance, nm and d₀: natural period of the block copolymer, 30 nm) in one region, and at 2 in the other region. In other words, one region had the lattice-lattice distance of 30 nm, and the other region had the distance of 60 nm.

This example coated the pattered film of grafted silsesquioxane with the second block copolymer, and annealed the coating film in the vapor of carbon disulfide solvent for 3 hours for microphase separation.

This treatment produced the columnar microdomains 203 of the PMMA segment, arranged while they were restricted by the second regions 107 of the oxidized film 401a, and continuous phase 204 of the PMAPOSS segment on the first regions 106 of the grafted silsesquioxane film 401 (refer to FIG. 4 (b)).

The columnar microdomains were upstanding on the substrate and regularly arranged on the substrate in the in-plane direction over a long distance while showing substantially no defects, with the d/d₀ ratio set at 1 and 2 (d: lattice-lattice distance, nm and d₀: natural period of the block copolymer, 30 nm).

The microdomains produced in this example were substantially free of defects and regularly arranged over a long distance. Thus, the surface conditions of the grafted silsesquioxane film were evaluated good ‘◯’, as shown in Table 1.

### Comparative Examples 1 to 3

Comparative Examples 1 to 3 used the first block copolymer and polystyrene incorporated with hydroxide group at the terminals (hereinafter sometimes simply referred to as “hydroxide-incorporated PS”) as the surface modifying agent in place of POSS-containing PMA used in Example 1, as shown in Table 1.

The comparative examples coated the Si wafer of increased hydroxide group concentration on the surface with hydroxide-incorporated PS dissolved in toluene by a spin coater (1H-360S, supplied by MIKASA Co.) at a rotational speed of 3000 rpm, in a manner similar to that for Example 1. The coating film of hydroxide-incorporated PS was about 40 nm thick.

Next, the coated Si wafer was heated at 170° C. for 72 hours in a vacuum oven. Then, the coated Si wafer was immersed in toluene and ultrasonically treated to remove the unreacted surface modifying agent (hydroxide-incorporated PS). This formed the grafted polystyrene film on the wafer.

Hydroxide-incorporated PS used in Comparative Examples 1 to 3 had respective number-average molecular weights (Mn) of 900, 3,700 and 10,000, as shown in Table 1.

Table 1 shows thickness of the grafted polystyrene film measured by spectral ellipsometry, and contact angle of hPMMA with the grafted polystyrene film. The contact angle of hPMMA with the Si wafer (as the substrate) surface was 0°.

Comparative Examples 1 to 3 patterned the grafted polystyrene film by EB lithography. Example 1 oxidized the grafted silsesquioxane film 401 by RIE with the patterned resist film 402 (thickness: 50 nm) serving as the mask (refer to FIG. 2 (e)). On the other hand, Comparative Examples 1 to 3 etched the grafted polystyrene film (not shown) in such a way that the substrate 201 was exposed to have a pattern of circles having a diameter of “r.” The RIE conditions were output: 100 W, oxygen gas pressure: 1 Pa, oxygen gas flow rate: 10 cm³/minute, and etching time: 5 to 10 seconds.

Comparative Examples 1 to 3 patterned the grafted polystyrene film to have 2 region types, wherein the d/d₀ ratio was set at 1 (d: lattice-lattice distance, nm and d₀: natural period of the block copolymer, 24 nm) in one region, and at 2 in the other region. In other words, one region had the lattice-lattice distance of 24 nm, and the other region had the distance of 48 nm.

Comparative Examples 1 to 3 coated the pattered film of grafted polystyrene with the first block copolymer, and annealed the coating films in the vapor of carbon disulfide solvent for 3 hours for microphase separation.

FIG. 12 (b) is an SEM image of the microdomains produced in Comparative Example 2. As shown, the microdomains produced by the microphase separation showed no effect of the chemical registration. Similarly, no effect of the chemical registration was observed in Comparative Examples 1 and 3, because the microdomains showed polygrain structures.

Thus, the surface conditions of the grafted polystyrene film produced in Comparative Examples 1 to 3 were evaluated bad ‘×’, as shown in Table 1, because of formation of the polygrain structures arranged.

### Comparative Examples 4 to 6

Comparative Examples 4 to 6 used the second block copolymer (natural period d₀: 30 nm) in place of the first block copolymer (natural period d₀: 24 nm). Moreover, these comparative examples patterned the grafted polystyrene film in such a way that the substrate was exposed to have a pattern of circles having a diameter of “r” in the same manner as in Comparative Examples 1 to 3, except that the grafted polystyrene film were patterned to have 2 region types, wherein the d/d₀ ratio was set at 1 (d: lattice-lattice distance, nm and d₀: natural period of the block copolymer, 30 nm) in one region, and at 2 in the other region.

Comparative Examples 4 to 6 3 coated the pattered films of grafted polystyrene with the second block copolymer, and annealed the coating films in the vapor of carbon disulfide solvent for 3 hours for microphase separation.

However, the microphase separation showed no effect of the chemical registration, because the microdomains had polygrain structures.

Thus, the surface conditions of the grafted polystyrene films produced in Comparative Examples 4 to 6 were evaluated bad ‘×’, because of formation of the polygrain structures arranged.

### (Results of Evaluation of the Polymer Thin Film)

The differential between the contact angle of hMPPA with the grafted polystyrene film and that of hMPPA with the substrate ranged from 18 to 32° in Comparative Examples 1 to 6, where the latter contact angle is 0°, as shown in Table 1.

By contrast, Examples 1 to 2 had the differential with the grafted silsesquioxane film sufficiently secured large 66°, resulting from the large contact angle (0°) of hMPPA with the grafted silsesquioxane film (66°).

Thus, it is demonstrated that the present invention produces the microdomains substantially free of defects and regularly arranged over a long distance, as shown in Table 1.

Examples 1 and 2 describe PMMA-b-PMAPOSS having a structure with the microdomains of PMMA distributed in the continuous phase of PMAPOSS. The similar results can be obtained with PMMA-b-PMAPOSS having a structure with the microdomains of PMAPOSS distributed in the continuous phase of PMMA.

The microdomains can be arranged similarly with PMMA-b-PMAPOSS having a lamellar microphase-separated structure using a grafted silsesquioxane film.

### Example 3

Example 3 describes an embodiment of producing a pattern substrate (patterned media). This example decomposed the columnar microdomains and removed them from the polymer thin film M following the steps shown in FIGS. 7 (a) and (b), in order to form the porous thin film on the substrate.

Example 3 produced the microphase-separated structure with the columnar microdomains 203 of PMMA upstanding on the substrate 201 (extending in the polymer thin film M thickness direction) following the procedure adopted in Example 1 (refer to FIG. 7 (a)). This example also adopted the pattern shown in FIG. 9, as in Example 1. The second block copolymer was also used, as in Example 1.

Next, PMMA-b-PMAPOSS was spread on the substrate 201 chemically patterned at intervals of 48 nm, which was twice as long as natural period d₀ (24 nm) of PMMA-b-PMAPOSS, to have the 40 nm thick film. The film was then exposed to the vapor of carbon disulfide solvent to develop the microphase-separated structure.

The structure had the microdomains of PMMA regularly arranged in the continuous phase of PMAPOSS.

The microdomains 203 were removed by oxygen-aided RIE to produce the porous thin film D (refer to FIG. 7 (b)). The RIE conditions were 1 Pa as oxygen gas pressure, 20 W as output and 90 seconds as etching time.

The surface conditions of the porous thin film were observed by a scanning electron microscope. It was found that the porous thin film D had fine, columnar holes H running through the thin film over the entire surface. The holes H, about 10 nm in diameter, were free of defects in the region whose surface was chemically pattered at intervals of lattice-lattice distance “d” (24 nm), and hexagonally arranged in a state of arranging in one direction, as revealed by the detailed observation.

Thickness of the porous thin film D was determined by the following procedure. Part of the thin film was separated by a sharp knife, and the differential level between the coated and uncoated substrate was observed by an AFM. The differential level was about 40 nm.

The fine hole H had an aspect ratio of 4, which is unobtainable by a spherical microdomain. Thickness of the porous thin film D as a microstructure remained substantially unchanged before and after RIE, which indicates that PMAPOSS is highly resistant to etching.

Next, the substrate 201 was dry-etched with CF₄ gas with the porous thin film D serving as the mask to transfer the porous thin film D pattern to the substrate 201. Shape of the fine hole and hole pattern were successfully transferred to the Si substrate to produce the patterned media 21a.

### Comparative Example 7

Comparative Example 7 produced the 40 nm thick PMMA-b-PMAPOSS film on the substrate in the same manner as in Example 3, except that the substrate was not pattered, and exposed the film to the vapor of carbon disulfide solvent to develop the microphase-separated structure. Then, the comparative example used the structure to produce the porous thin film D (refer to FIG. 7 (a)).

The porous thin film D surface was observed by a scanning electron microscope. It was found that the film had the fine holes arranged hexagonally microscopically, but had a polygrain structure macroscopically in the region with the hexagonally arranged holes and a number of lattice defects in the grain boundaries.

It should be further understood by those skilled in the art that although the foregoing description has been made on embodiments of the invention, the invention is not limited thereto and various changes and modifications may be made without departing from the spirit of the invention and the scope of the appended claims.

### DESCRIPTION OF REFERENCE NUMERALS

21 Patterned media
21a Patterned media
21b Patterned media
106 First region
107 Second region
201 Substrate
202 Coating film (polymer layer)
203 Microdomain
204 Continuous phase
401 Film of grafted silsesquioxane
401a Oxidized film of grafted silsesquioxane
A1 First segment
A2 Second segment
M Polymer thin film
d₀ Natural period

1. A method for producing a polymer thin film, comprising the steps of:
a first step of disposing a polymer layer on a substrate, the polymer layer containing a block copolymer having at least a first segment and a second segment; and
a second step of subjecting the polymer layer to a microphase separation to regularly arrange, on the substrate in an in-plane direction, a plurality of microdomains containing the second segment component in a continuous phase containing the first segment component,
further including the step of, before the first step, forming a film of grafted silsesquioxane on the substrate in such a way that the film corresponds to the continuous phase, and forming a pattern different in chemical properties from the film of grafted silsesquioxane in such a way that the pattern corresponds to the microdomain arrangement.

2. The method for producing a polymer thin film according to claim 1, wherein the film of grafted silsesquioxane is of grafted polyhedral oligomeric silsesquioxane.

3. The method for producing a polymer thin film according to claim 1, wherein the microdomains are arranged at periods d which is an integral multiple of the natural period do of the pattern.

4. The method for producing a polymer thin film according to claim 1, wherein the pattern is different in chemical properties from the film of grafted silsesquioxane in that the pattern is more wettable with the second segment component than the film of grafted silsesquioxane.

5. The method for producing a polymer thin film according to claim 1, wherein the microdomains are columnar and upstanding in the polymer layer thickness direction.

6. The method for producing a polymer thin film according to claim 1, wherein the microdomains are lamellar and upstanding in the polymer layer thickness direction.

7. The method for producing a polymer thin film according to claim 1, wherein the block copolymer has a silsesquioxane skeleton in the first or second segment.

8. The method for producing a polymer thin film according to claim 1, wherein the second step is carried out while exposing the polymer layer to a vapor of good solvent to at least one of the first and second segments of the block copolymer.

9. A method for producing a patterned media, comprising the steps of:
forming, on a substrate, the polymer thin film produced by the method according to claim 1 to have a plurality of the microdomains arranged in the continuous phase; and
removing one of the continuous phase and the microdomains from the polymer thin film.

10. The method for producing a patterned media according to claim 9, further including the step of etching the substrate with the other of the remaining continuous phase or the microdomains as a mask, after the step of removing one of the continuous phase and the microdomains from the polymer thin film.

11. A polymer thin film produced by the method according to claim 1.

12. A patterned media produced by the method according to claim 9.

13. A surface modifying agent for modifying a surface of substrate on which a polymer thin film is to be formed,
wherein the surface modifying agent comprises a polymer compound having:
a divalent organic group having a functional group capable of coupling to a hydroxide group present on a substrate surface; and
a polymer chain having, in a side chain, a monovalent functional group containing a polyhedral oligomeric silsesquioxane skeleton.

14. The surface modifying agent according to claim 13, wherein the polymer compound is represented by the following formula:
I-D-P-T
(wherein, I is an alkyl group, D is 1,1-diphenylethylene as the divalent organic group having a functional group capable of coupling to the hydroxide group present on the substrate surface, P is polymethacrylate as the polymer chain having, in the side chain, a monovalent functional group containing a polyhedral oligomeric silsesquioxane skeleton, and T is an alkyl group).
